(19) United States
(12) Patent Application Publication
(10) Pub. No.: US 2008/0253278 A1
(43) Pub. Date: Oct. 16, 2008

(54) Techniques to Compress Modulation Patterns for Adaptive Bitloading

(76) Inventors: Mikhail Lyakh, Prospekt Toreza (RU); Aliaksei Chapyzhenka, Budapeshtskaya str (RU)

Correspondence Address: INTEL CORPORATION;c/o INTELLEVATE, LLC, P.O. BOX 52050, MINNEAPOLIS, MN, 55402, US

(21) Appl. No.: 10/588,950

(22) PCT Filed: Apr. 27, 2006
(86) PCT No.: PCT/RU06/00216

§ 371 Date: Aug. 9, 2006

(51) Int. Cl. H04J 11/00

(52) U.S. Cl. 370/204

(57) ABSTRACT

An embodiment of the present invention provides a method, comprising using a predetermined limited set of modulation patterns to perform adaptive bit loading (ABL) to compress the modulation patterns in wireless communications.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates the link initiation with a conventional ABL technique of an embodiment of the present invention;

FIG. 2 illustrates a flowchart of the adaptation mechanism at station 2 according to one embodiment of the present invention; and

FIG. 3 illustrates the link initiation using an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate

### BACKGROUND

Wireless networks have grown increasingly in importance and have varying uses. Adaptive bitloading is a technique in wireless communications that is a promising method for improving orthogonal frequency division multiplexing (OFDM) data transmission in fading channels. This technique implies distributing constellations through the subcarriers such that subcarriers located at the frequencies dumped by channel are assigned with more robust constellations, and the subcarriers ‘amplified’ by channel are assigned with larger constellations. The ABL techniques improve the total link throughput as well as decrease packet and bit error rates.

However, at least one of the main problems in ABL is the overhead of the information sent due to bitloading patterns exchange. Thus, a strong need exists for techniques to compress modulation patterns for adaptive bitloading. corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like), wireless wide are networks (WWAN), wireless metropolitan area networks (WMAN) and Mesh networks.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

An adaptive bitloading (ABL) technique is a promising method for improving orthogonal frequency division multiplexing (OFDM) data transmission in fading channels. This technique may use constellation distribution through the subcarriers such that subcarriers located at the frequencies dumped by a channel are assigned with more robust constellations and the subcarriers ‘amplified’ by a channel are assigned with larger constellations. The ABL technique may improve total link throughput as well as decrease packet and bit error rates.

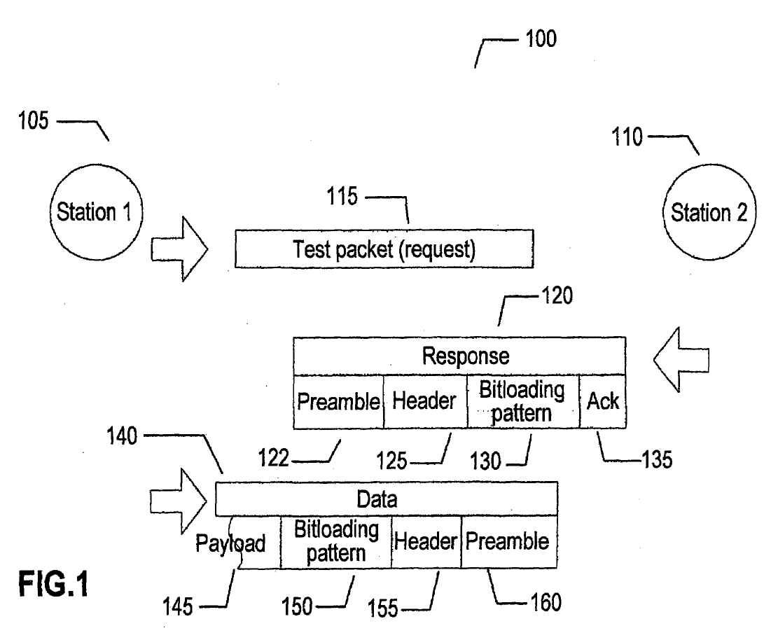

As illustrated in FIG. 1, generally as 100, in an embodiment of the present invention, one of the main problems in ABL is the overhead of the information sent due to bitloading patterns exchange. Station 1 (data sender) 105 sends to Station 2 (data recipient) 110 a testing packet 115 which also may play a role of request for sending. In the response 120, Station 2 110 sends to Station 1 105 a packet containing bitloading pattern 130 (also, preamble 122, header 125 and ACK 135 may be included). Next, Station 1 105 may send data packet 140 containing data modulated according to the bitloading pattern 150, as well as the pattern itself, since receiver at Station 2 110 requires the pattern before the data arrived, to be able to demodulate it. Also included may be payload 145, header 155, and preamble 160.

One can see that the bitloading pattern 150 may be required to be sent in both directions therefore double-consuming the channel resource.

Moreover, for excluding packet loss, the bitloading information should be sent with highest robustness, i.e. with highest redundancy. In the case of BPSK transmission with ½ code rate, the full bitloading pattern consumes 2 log₂ N_{mod} OFDM symbols, where N_{mod} is the number of constellations allowed. For example, and not by way of limitation, 5 constellations (BPSK, QPSK, QAM16, QAM64, or Null) require at least 5 OFDM symbols. Practically, the number of the OFDM symbols required will be 6 or higher, since the constellation number is difficult to put into a fractional number of bits, plus some bits may be occupied by scrambler bits and tail bits of the error-correcting code.

It is evident, that OFDM modulation is robust to multipath distortions only if r.m.s. channel delay is much less than the cyclic prefix duration. Since cyclic prefix is usually less or equal to ¼ of the OFDM symbol duration, the channel frequency response is rather smooth, which makes the bulk of modulation patterns in ABL systems impossible.

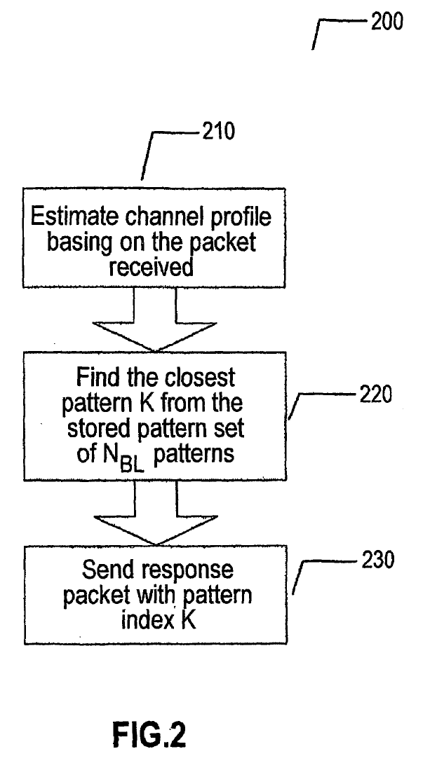

Turning now to FIG. 2, shown generally at 200, is a flowchart of the adaptation mechanism at station 2 according to one embodiment of the present invention. At 210 an embodiment of the present method estimates the channel profile based on packet received. Next, at 220, the closest pattern K is determined from the stored pattern set of N_{BL} patterns and at 230 a response is then sent at with pattern index K.

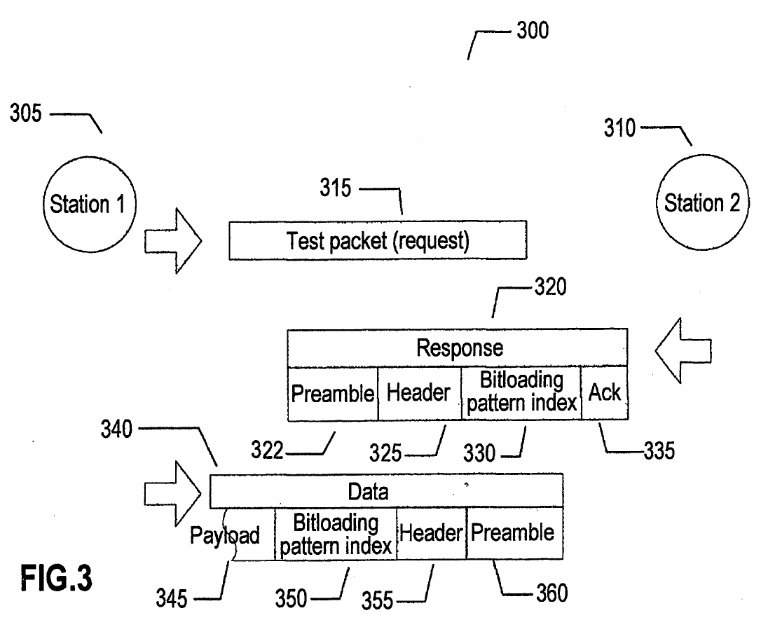

As shown in FIG. 3, generally at 300, in an embodiment of the present invention, the number of bitloading patterns may be limited by some number, which is based on channel smoothness property. Thus, the number of allowed patterns is limited by some NBL patterns which may be much less than N_{mod}^{Nsc} patterns (N_{sc} is the number of subcarriers in an OFDM symbol). In both Station 1 305 and Station 2 310, the set of NBL patterns may be stored a-priori. Station 1 305 may send a test packet (request) 315 to station 2 310. At the packet reception, Station 2 310 determines which of the NBL patterns is best for the current channel conditions and sends back 320 to Station 1 305 the index of the pattern 330 instead of the pattern itself as accomplished in FIG. 1 (the response 320 may include, preamble 322, header 325 and ack 335). Station 1 305 may use the pattern index to obtain the bitloading pattern, modulate data 340 with the pattern, and send the data 340 (which may include payload 345, header 355, and preamble 360) to Station 2 310 advanced by the bitloading pattern index 330.

In an embodiment of the present invention and not limited in this respect or to any wireless standard, a study of the method proposed as applied to 802.11a link improved by ABL technique has been accomplished. The simulations show that N_{BL}=214 covers 80% of possible channels in typical indoor conditions with r.m.s. tap delay below 50 ns. Also, the simulations performed show no increase of packet errors due to limitation of the bitloading pattern set. Thus, using an embodiment of the present invention it is possible to send 1 OFDM symbol instead of 5 and significantly reduce packet overhead compared to the case when full bitloading information is sent. It also should be noted that fast methods for searching the closest bitloading pattern in the given pattern set may be developed by specific indexing of the pattern set. In addition, an embodiment of the present invention simplifies the modulator and demodulator, since the modulation pattern set is significantly limited.

An embodiment of the present invention also provides a machine-accessible medium that provides instructions, which when accessed, cause a machine to perform operations comprising using a predetermined limited set of modulation patterns to perform advanced bit loading (ABL) to compress said modulation patterns in wireless communications. The machine-accessible medium of an embodiment of the present invention may further comprise the instructions causing the machine to perform operations further comprising limiting by some number the predetermined limited set of modulation patterns based on channel smoothness property and may also further comprise the instructions causing the machine to perform operations further comprising limiting said number of allowed patterns to some set of N_{BL} patterns which is less than N_{mod}^{Nsc} patterns with N_{sc} being is the number of subcarriers in an OFDM symbol.

An embodiment of the present invention also provides a system, comprising a first wireless station; and a second wireless station in communication with the first wireless station using an adaptive bitloading (ABL) technique, wherein the first and the second wireless stations are capable of using a predetermined limited set of modulation patterns to perform the ABL. The system may also provide that the predetermined limited set of modulation patterns is limited by some number, which is based on channel smoothness property.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a wireless station operable in a wireless network using an adaptive bitloading (ABL) technique, wherein said wireless station is capable of using a predetermined limited set of modulation patterns to perform said ABL.

2. The apparatus of claim 1, wherein said predetermined limited set of modulation patterns is limited by some number, which is based on channel smoothness property.

3. The apparatus of claim 1, wherein said number of allowed patterns is limited to some set of N_{BL} patterns which is less than N_{mod}^{Nsc} patterns with N_{sc} being is the number of subcarriers in an OFDM symbol.

4. The apparatus of claim 3, wherein said N_{BL} patterns are stored a-priori.

5. The apparatus of claim 1, further comprising at least one additional wireless station that is capable of receiving packets from said wireless station and upon packet reception of said packets by said at least one additional wireless station, said at least one additional wireless station determines which of said N_{BL} patterns is best for current channel conditions and sends back to said wireless station an index of a pattern instead of said pattern itself.

6. The apparatus of claim 5, wherein said wireless station uses said pattern index to obtain said bitloading pattern, modulate data with said pattern, and send data to said at least one additional wireless station advanced by said bitloading pattern index.

7. The apparatus of claim 6, wherein said wireless station is capable of developing fast methods for searching a closest bitloading pattern in a given pattern set by specific indexing of said pattern set.

8. A method, comprising:
using a predetermined limited set of modulation patterns to perform adaptive bit loading (ABL) to compress said modulation patterns in wireless communications.

9. The method of claim 8, further comprising limiting by some number said predetermined limited set of modulation patterns based on channel smoothness property.

10. The method of claim 8, further comprising limiting said number of allowed patterns to some set of NBL patterns which is less than N_{mod}^{Nsc} patterns with N_{sc} being is the number of subcarriers in an OFDM symbol.

11. The method of claim 10, further comprising storing said N_{BL} patterns a-priori.

12. The method of claim 8, further comprising receiving packets from said wireless station by at least one additional wireless station and upon packet reception of said packets by said at least one additional wireless station, said at least one additional wireless station determines which of said N_{BL} patterns is best for current channel conditions and sends back to said wireless station an index of a pattern instead of said pattern itself.

13. The method of claim 12, further comprising using said pattern index by said wireless station to obtain said bitloading pattern and modulating data with said pattern and sending data to said at least one additional wireless station advanced by said bitloading pattern index.

14. The method of claim 13, further comprising developing fast methods for searching a closest bitloading pattern in a given pattern set by specific indexing of said pattern set by said wireless station.

15. A machine-accessible medium that provides instructions, which when accessed, cause a machine to perform operations comprising:
using a predetermined limited set of modulation patterns to perform adaptive bit loading (ABL) to compress said modulation patterns in wireless communications.

16. The machine-accessible medium of claim 15, further comprising said instructions causing said machine to perform operations further comprising limiting by some number said predetermined limited set of modulation patterns based on channel smoothness property.

17. The machine-accessible medium of claim 15, further comprising said instructions causing said machine to perform operations further comprising 8, further comprising limiting said number of allowed patterns to some set of N_{BL} patterns which is less than N_{mod}^{Nsc} patterns with N_{sc} being is the number of subcarriers in an OFDM symbol.

18. The machine-accessible medium of claim 17, further comprising said instructions causing said machine to perform operations further comprising storing said N_{BL} patterns a-priori.

19. The machine-accessible medium of claim 15, further comprising said instructions causing said machine to perform operations further comprising receiving packets from said wireless station by at least one additional wireless station and upon packet reception of said packets by said at least one additional wireless station, said at least one additional wireless station determines which of said N_{BL} patterns is best for current channel conditions and sends back to said wireless station an index of a pattern instead of said pattern itself.

20. The machine-accessible medium of claim 19, further comprising said instructions causing said machine to perform operations further comprising using said pattern index by said wireless station to obtain said bitloading pattern and modulating data with said pattern and sending data to said at least one additional wireless station advanced by said bitloading pattern index.

21. The machine-accessible medium of claim 20, further comprising said instructions causing said machine to perform operations further comprising developing fast methods for searching a closest bitloading pattern in a given pattern set by specific indexing of said pattern set by said wireless station.

22. A system, comprising:
a first wireless station; and
a second wireless station in communication with said first wireless station using an, adaptive bitloading (ABL) technique, wherein said first and said second wireless stations are capable of using a predetermined limited set of modulation patterns to perform said ABL.

23. The system of claim 22, wherein said predetermined limited set of modulation patterns is limited by some number, which is based on channel smoothness property.

24. The system of claim 22, wherein said number of allowed patterns is limited to some set of N_{BL} patterns which is less than N_{mod}^{Nsc} patterns with N_{sc} being is the number of subcarriers in an OFDM symbol.

25. The system of claim 24, wherein said N_{BL} patterns are stored a-priori.

26. The system of claim 22, wherein said second wireless station is capable of receiving packets from said first wireless station and upon packet reception of said packets by said second wireless station, said second wireless station determines which of said N_{BL} patterns is best for current channel conditions and sends back to said first wireless station an index of a pattern instead of said pattern itself.

27. The system of claim 26, wherein said first wireless station uses said pattern index to obtain said bitloading pattern, modulate data with said pattern, and send data to said second wireless station advanced by said bitloading pattern index.

28. The system of claim 27, wherein said first wireless station is capable of developing fast methods for searching a closest bitloading pattern in a given pattern set by specific indexing of said pattern set.
